(19) United States
(12) Patent Application Publication
(10) Pub. No.: US 2021/0129987 A1
(43) Pub. Date: May 6, 2021

(54) AERIAL VEHICLES, METHODS OF IMAGING A TUNNEL AND METHODS OF IMAGING A SHAFT

(71) Applicant: SINGAPORE UNIVERSITY OF TECHNOLOGY AND DESIGN, Singapore (SG)

(72) Inventors: Shaohui FOONG, Singapore (SG); Win KYI HLA, Singapore (SG); Chee How TAN, Singapore (SG); Danial Sufiyan BIN SHAIFUL, Singapore (SG); Win Luke Thura SOE, Singapore (SG); Hock Beng LIM, Singapore (SG); Sai-Kit YEUNG, Singapore (SG)

(73) Assignee: Singapore University of Technology and Design, Singapore (SG)

(21) Appl. No.: 17/041,497

(22) PCT Filed: Mar. 26, 2019
(86) PCT No.: PCT/SG2019/050167

§ 371 Date: Sep. 25, 2020

(30) Foreign Application Priority Data
Mar. 26, 2018 (SG) 10201802492Y

(51) Int. Cl. B64C 39/02; B64D 47/08; G05D 1/10; G01N 21/88

(52) U.S. Cl. CPC B64C 39/024; B64D 47/08; G05D 1/10; G01N 21/8803; B64C 2201/123; B64C 2201/127; B64C 2201/027; B64C 2201/108; B64C 2201/141

(57) ABSTRACT

According to various embodiments, there is provided an aerial vehicle. The aerial vehicle includes: an airframe comprising a central member defining a longitudinal axis; a gimbal coupled to the central member; a camera mounted on the gimbal to face a direction at least substantially orthogonal to the longitudinal axis; wherein the gimbal is rotatable about the longitudinal axis to spin the camera around the longitudinal axis; and a propulsion means configured to propel the aerial vehicle, wherein the propulsion means is offset from the camera along the longitudinal axis.

### CROSS-REFERENCE TO RELATED APPLICATIONS

This application claims the benefit of Singapore Patent Application number 10201802492Y filed 26 Mar. 2018, the entire contents of which are incorporated herein by reference for all purposes.

### TECHNICAL FIELD

Various embodiments relate to aerial vehicles, methods of imaging a tunnel and methods of imaging a shaft.

### BACKGROUND

Some enclosed infrastructures, such as train tunnels, sewage tunnels and other underground networks, require an infrastructure surveillance system that generates minimum disturbance to its surroundings while capturing as much data as possible. Many infrastructure surveillance systems today are ground based, making them vulnerable to debris and liquid on the floor of the infrastructure as they operate. Conventional robots may not be ideal as infrastructure surveillance systems. For example, unmanned ground vehicles (UGV) are unable to traverse sewage tunnels filled with silts, sewerage or debris. Unmanned surface vessels (USV) can only work in tunnels that are partially filled with a liquid of highly diluted consistency. Pipeline and tunnel robots can only work in small to medium diameter pipes and may require complex hoisting and winching mechanisms for deployment and retrieval.

### SUMMARY

According to various embodiments, there may be provided an aerial vehicle including: an airframe including a central member defining a longitudinal axis; a gimbal coupled to the central member; a camera mounted on the gimbal to face a direction at least substantially orthogonal to the longitudinal axis; wherein the gimbal is rotatable about the longitudinal axis to spin the camera around the longitudinal axis; and a propulsion means configured to propel the aerial vehicle, wherein the propulsion means is offset from the camera along the longitudinal axis.

According to various embodiments, there may be provided a method of imaging a shaft, the method including: flying an aerial vehicle along a depthwise direction of the shaft; wherein the aerial vehicle includes an airframe defining a longitudinal axis, and a camera mounted on the airframe to face a direction at least substantially orthogonal to the longitudinal axis; wherein the longitudinal axis is at least substantially parallel to the depthwise direction when the aerial vehicle is in flight; rotating the aerial vehicle about the longitudinal axis while the aerial vehicle is in flight such that the camera revolves around the longitudinal axis to capture a spiral panoramic image; and reconstructing a virtual three-dimensional model of the shaft based on the spiral panoramic image.

According to various embodiments, there may be provided a method of locating an aerial vehicle in an enclosed space, the method including: storing geometrical information about the enclosed space in a memory; measuring a plurality of distances using a plurality of range sensors, each range sensor mounted on a respective position on the airframe; wherein each measured distance is a distance between the respective position and a nearest surface of the enclosed space from the respective position; and determining a planar position of the aerial vehicle based on the measured distances and the geometrical information.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 shows a simplified diagram of an aerial vehicle according to various embodiments.

FIG. 2 shows a simplified diagram of an aerial vehicle according to various embodiments.

FIGS. 3A and 3B show simplified illustrations of a method of imaging a tunnel.

FIGS. 4A and 4B show simplified illustrations of a method of imaging a shaft.

FIG. 5 illustrates an implementation of the aerial vehicle according to various embodiments.

FIG. 6 shows a diagram of a revolving camera system according to various embodiments.

FIG. 7 shows a diagram that illustrates a method of mapping a tunnel according to various embodiments

FIG. 8 shows a planar cross-section with two parallel lines which is the geometry of a tunnel reduced to a 2D planar form.

FIG. 9 shows a circular cross-section which is the geometry of a vertical shaft reduced to a 2D form.

FIG. 10 shows a visual illustration of the optimization problem in formulated in 2D, where the sensor placements and the spatial constraints are illustrated in a 2D plane.

FIGS. 11A-11D shows possible, but not limiting configurations of the sparse array sensors according to various embodiments.

FIG. 12 shows graphs that illustrate the results of the numerical simulation.

FIG. 13 shows a photo of a prototype of the aerial vehicle used in the experiments.

FIG. 14 shows a graph that plots the result of a first experiment.

FIG. 15 shows a graph that plots the result of a second experiment.

FIG. 16 shows the results of a third experiment.

FIG. 17 shows the results of a fourth experiment.

FIG. 18 shows a graph that plots the absolute Euclidean error r throughout the experimental flight.

### DESCRIPTION

Embodiments described below in context of the aerial vehicles are analogously valid for the respective methods, and vice versa. Furthermore, it will be understood that the embodiments described below may be combined, for example, a part of one embodiment may be combined with a part of another embodiment.

It will be understood that any property described herein for a specific aerial vehicle may also hold for any aerial vehicle described herein. It will be understood that any property described herein for a specific method may also hold for any method described herein. Furthermore, it will be understood that for any aerial vehicle or method described herein, not necessarily all the components or steps described must be enclosed in the device or method, but only some (but not all) components or steps may be enclosed.

It should be understood that the terms “on”, “over”, “top”, “bottom”, “down”, “side”, “back”, “left”, “right”, “front”, “lateral”, “side”, “up”, “down” etc., when used in the following description are used for convenience and to aid understanding of relative positions or directions, and not intended to limit the orientation of any device, or structure or any part of any device or structure. In addition, the singular terms “a”, “an”, and “the” include plural references unless context clearly indicates otherwise. Similarly, the word “or” is intended to include “and” unless the context clearly indicates otherwise.

The term “coupled” (or “connected”) herein may be understood as electrically coupled or as mechanically coupled, for example attached or fixed, or just in contact without any fixation, and it will be understood that both direct coupling or indirect coupling (in other words: coupling without direct contact) may be provided.

In order that the invention may be readily understood and put into practical effect, various embodiments will now be described by way of examples and not limitations, and with reference to the figures.

According to various embodiments, an aerial vehicle may be provided for inspecting covered infrastructures. The aerial vehicle may be equipped with a revolving camera system. The revolving camera system may capture panoramic images of the immediate surroundings as the aerial vehicle moves forward. Unlike a conventional 360° camera with wide-angled lens, the revolving camera system may capture images of entire lateral surfaces, and the images can be of high fidelity and minimal optical distortion, while only using a single camera. The images captured by the revolving camera system may be stitched together to virtually reconstruct the infrastructure for detection of damages such as cracks and deterioration. These images may be processed to reconstruct the infrastructure in a virtual space and used for detecting cracks and deteriorations. The aerial vehicle may be an unmanned aerial vehicle (UAV) that may autonomously carry out visual inspection of the covered infrastructures. The aerial vehicle may have a minimal set of simple navigation sensors, so that the weight, battery and computational power required by the navigation sensors are low. The navigation sensors may include a sparse array of time-of-flight (ToF) rangefinders that are arranged in an optimal fashion to localize in different environments, such as horizontal tunnels and vertical shafts. The aerial vehicle may be powered by lithium-ion batteries that have higher energy denser than traditional lithium-polymer batteries to enhance the endurance of the aerial vehicle.

One possible application of the aerial vehicles according to various embodiments, may be to inspect underground sewerage infrastructure, like the Deep Tunnel Sewerage System (DTSS) in Singapore which is large and extensive. The tunnels in the DTSS are protected with specially-designed Corrosion Protection Lining and periodic inspections are required. The environment inside these tunnels, which extend more than 30 m underground, is hazardous and human access is difficult and dangerous. The aerial vehicle may be able access the tunnels of about 3 to 6 m in diameter via the vertical direct access shaft of about 3 to 5 metres in diameter, without requiring winch and hoisting system like conventional pipeline robots. Being agile and versatile to traverse 3D space, the aerial vehicle may be able to enter the tunnels even in the presence of sewerage, silts, debris and unknown obstacles in a fully operational sewerage system.

FIG. 1 shows a simplified diagram of an aerial vehicle 100 according to various embodiments. The aerial vehicle 100 may be a rotary aerial vehicle, as such as a multicopter, for example, a quadcopter. The airframe of the aerial vehicle 100 may include a central member 104 and a plurality of arms 106 that extend out of the central member 104. To facilitate description of the orientations and positions of the aerial vehicle components, the central frame 104 is referred to as defining a body frame. The body frame has a longitudinal (X) axis 120, a lateral (Y) axis 130 and a height (Z) axis 140. Each of the X axis 120, the Y axis 130 and the height axis 140 extend perpendicular to each other and they may intersect in a centre of gravity of the aerial vehicle 100. The height axis 140 is not shown in FIG. 1 as it is perpendicular to the plane of the drawing sheet.

The aerial vehicle may include rotors 108 as the propulsion means. At least one rotor may be coupled to each respective arm 106. The aerial vehicle 100 may include a camera system 102 coupled to the central member 104. The camera system 102 may include a camera 110. The camera 110 may be fixed in position and orientation with respect to the camera system 102. The camera system 102 may be configured to rotate 150 about the X axis 120, for example using a rotatable gimbal of the camera system 102. As the camera system 102 rotates, the camera 110 may revolve around the X axis 120. The camera system 102 may be an internal camera system. The internal camera system may be housed within a cavity in the central frame 104. The central frame 104 may include an at least substantially transparent window aligned, for example longitudinally aligned, with the camera 110 so that the camera 110 may receive light from outside of the central frame 104. Alternatively, the camera system 102 may be an external camera system, mounted outside of the central frame. The external camera system may rotate around the central frame 104. For example, the camera system 102 may include a ring-shaped gimbal that receives the central frame in a centre of the gimbal, for example, in a concentric manner.

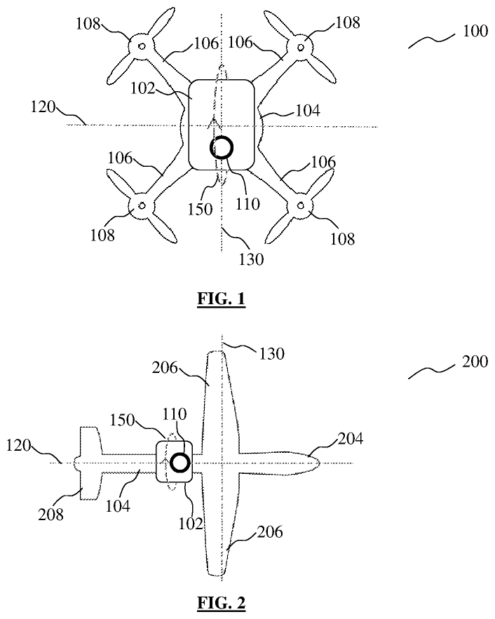

FIG. 2 shows a simplified diagram of an aerial vehicle 200 according to various embodiments. The aerial vehicle 200 may be different from the aerial vehicle 100, in that it may be a fixed wing aerial vehicle. As such, the airframe of the aerial vehicle 200 may include a central member 104 that is a fuselage, and a pair of wings 206. Similar to the description with respect to the aerial vehicle 100, the central frame 104 is referred to as defining a body frame, and the body frame has a longitudinal (X) axis 120, a lateral (Y) axis 130 and a height (Z) axis 140. The pair of wings 206 may be coupled at wing roots, to opposing lateral sides of the fuselage. In other words, a straight line joining the wing tips of the pair of wings 206 may be at least substantially parallel to the Y axis 130. The fuselage may include a nose 204 and a tail 208. A straight line joining the nose 204 and the tail 208 may be at least substantially parallel to the X axis 120. Similar to the aerial vehicle 100, the aerial vehicle 200 may also include the camera system 102 which may be configured to rotate 150 about the X axis 120, so as to spin the camera 110 about the X axis 120.

According to various embodiments, the aerial vehicles 100 or 200 may be unmanned aerial vehicles (UAV), which may also be referred herein as aerial robots. The aerial vehicles 100 or 200 may include a datalink configured to receive and transmit data between the aerial vehicle and a ground control station. The aerial vehicles may be designed and optimized to accommodate the revolving camera system and achieve high endurance. The aerial vehicles may feature a fine-tuned propulsion system which allows for maximum cooling of its sensors and payloads. The aerial vehicles may be manually piloted semi-autonomously using long range radio and video transmission. In cases where manual control is not necessary or not possible, the aerial vehicles may fly autonomously using pre-planned flight paths. The aerial vehicles may include a memory storing geometrical information about an enclosed space. Alternatively, the geometrical information about the enclosed space may be stored external to the aerial vehicle. A processor, either onboard the aerial vehicle or external to the aerial vehicle, may determine a planar position of the aerial vehicle in the enclosed space based on measurements from range sensors on the aerial vehicle and further based on the geometrical information.

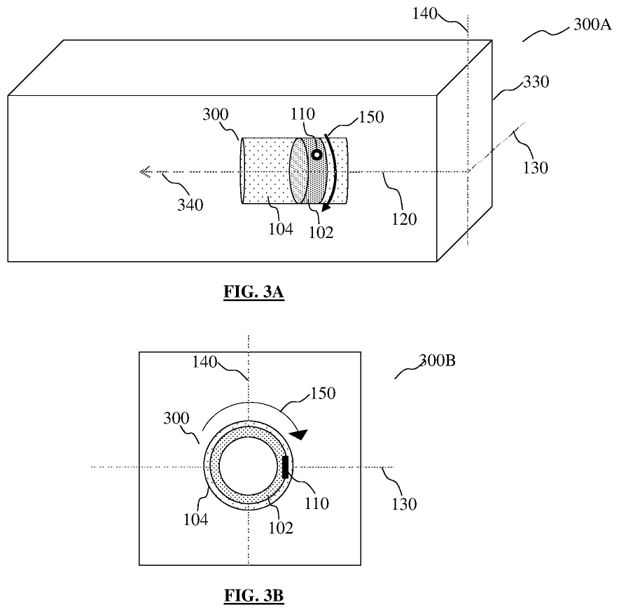

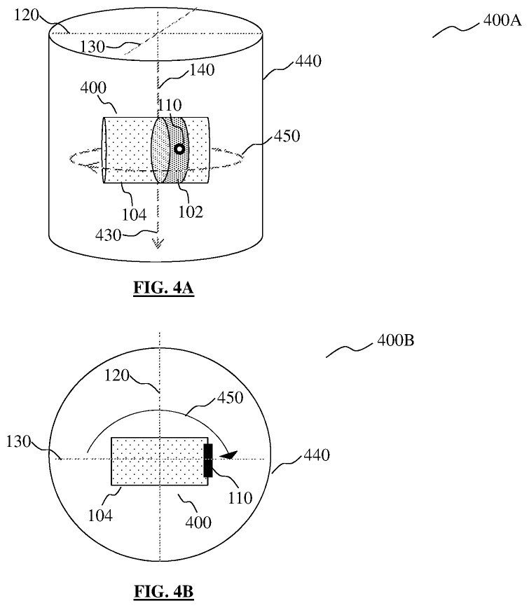

FIGS. 3A and 3B show simplified illustrations of a method of imaging a tunnel. The method may include sending an aerial vehicle 300 into the tunnel 330. For simplicity, the aerial vehicle 300 is not fully illustrated and instead, is only represented by its central frame 104 in these figures. The aerial vehicle 300 may be any one of the aerial vehicle 100 or 200.

FIG. 3A illustrates the method with a side perspective view 300A of a tunnel 330. For clarity in the figure, the Y axis 130 and the Z axis 140 are shown outside of the aerial vehicle 300, although it should be understood that these axes are defined with respect to the central frame 104. The aerial vehicle 300 may travel along a path 340. The path 340 may be at least substantially parallel to a lengthwise direction of the tunnel 330, such that the longitudinal axis 120 may be at least substantially parallel to the lengthwise direction of the tunnel 330 when the aerial vehicle 300 is in flight. If the tunnel 330 has a symmetrical geometry, the aerial vehicle 300 may ideally fly along a centre of the tunnel 330. As the aerial vehicle 300 travels along the path 340, the gimbal of the camera system 102 may rotate about the X axis, causing the camera 110 to revolve around the X axis. The camera 110 may capture images at a regular rate, as the gimbal rotates at least substantially continuously and as the aerial vehicle 300 travels. The rotation movement by the gimbal and the translational movement by the aerial vehicle 300 may cause the camera 110 to capture a spiral panoramic image of the interior of the tunnel 330. The camera system 102 may include a ranging sensor that may measure a distance between the camera 110 and a nearest surface. The ranging sensor may emit an electromagnetic (EM) wave and receive the EM wave that bounces off the nearest surface of the tunnel 330. The ranging sensor may determine the distance between the camera 110 and the nearest surface of the tunnel 330 based on the time taken between emitting the EM wave and receiving the reflected EM wave. The aerial vehicle 300 may transfer the spiral panoramic image and the output of the ranging sensor to a processor. The processor, which may be onboard the aerial vehicle 300, or external to the aerial vehicle 300, may convert the spiral panoramic image into a three-dimensional visual model, with the aid of the ranging sensor measurements.

FIG. 3B illustrates the method of FIG. 3A, with a widthwise cross-sectional view 300B of the tunnel 330. While the figures depict the tunnel 330 as being cuboid in shape, it should be understood that the method is applicable for tunnels of other shapes and geometry.

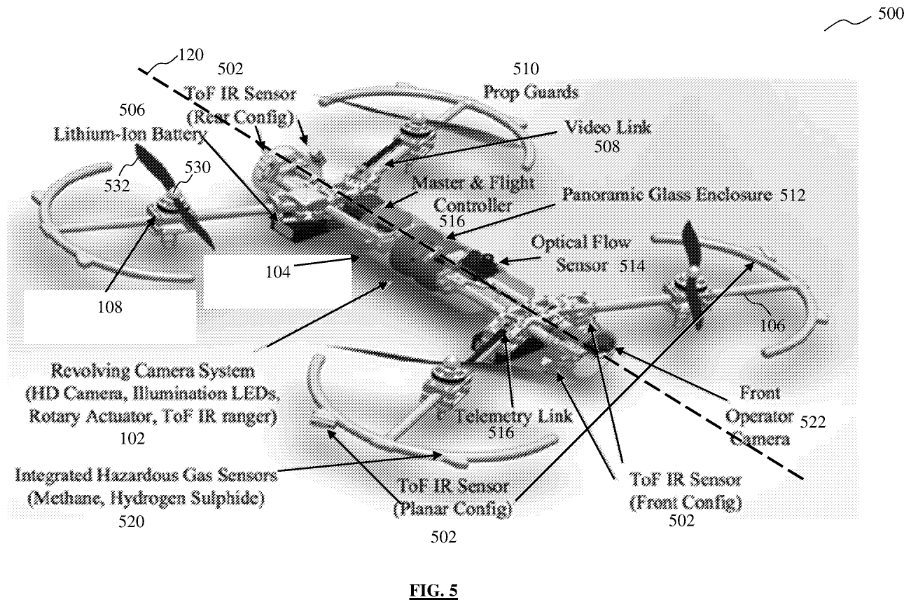

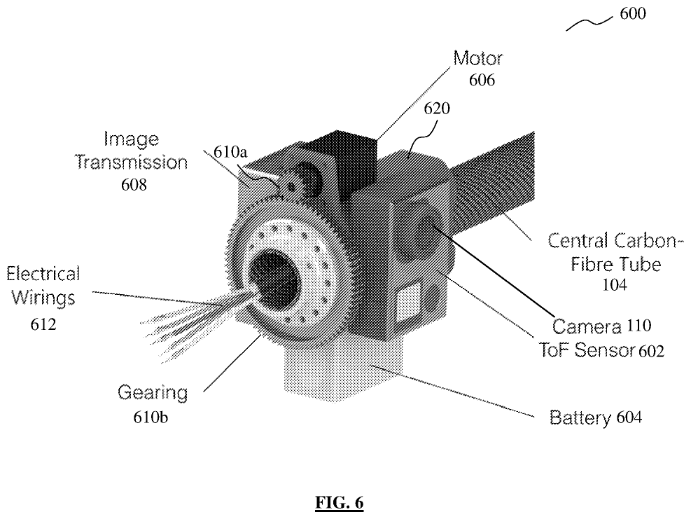

FIGS. 4A and 4B show simplified illustrations of a method of imaging a shaft. The method may include sending an aerial vehicle 400 into the shaft 440. For simplicity, the aerial vehicle 400 is not fully illustrated and instead, is only represented by its central frame 104 in these figures. The shaft 440 may be different from the tunnel 330 in its orientation, in that the shaft 440 is at least substantially vertical whereas the tunnel is at least substantially horizontal. In other words, flying out of an underground shaft 440 may require the aerial vehicle 300 to travel in an opposite direction from the pull of gravity. The aerial vehicle 400 may be any one of the aerial vehicle 100 or 200. Alternatively, the aerial vehicle 400 may be different from any one of the aerial vehicle 100 or 200, in that its camera system 102 may be exclude a gimbal 102. The camera 110 may be fixed in position and/or orientation with respect to the central frame 104 of the aerial vehicle 400, either mechanically or as controlled by a motor of the gimbal 102.

FIG. 4A illustrates the method with a side perspective view 400A of a shaft 440. For clarity in the figure, the X axis 120 and the Y axis 130 are shown outside of the aerial vehicle 400, although it should be understood that these axes are defined with respect to the central frame 104. The aerial vehicle 400 may travel along a path 430. The path 430 may be at least substantially parallel to a depthwise direction of the shaft 440, such that the longitudinal axis 120 may be at least substantially perpendicular to the depthwise direction of the shaft 440 when the aerial vehicle 400 is travelling along the shaft 440. If the shaft 440 has a symmetrical geometry, the aerial vehicle 400 may ideally fly along a centre of the shaft 440. As the aerial vehicle 400 travels along the path 430, the aerial vehicle 400 may also spin 450 about the Z axis 140, causing the camera 110 to revolve around the Z axis 140. The camera 110 may capture images at a regular rate, as the aerial vehicle 400 rotates 450 and travels along the shaft 440. The rotation movement and translational movement by the aerial vehicle 400 may cause the camera 110 to capture a spiral panoramic image of the interior of the shaft 440. The camera system 102 may include a ranging sensor that may measure a distance between the camera 110 and a nearest surface. The ranging sensor may emit an electromagnetic (EM) wave and receive the EM wave that bounces off the nearest surface of the shaft 440. The ranging sensor may determine the distance between the camera 110 and the nearest surface of the shaft 440 based on the time taken between emitting the EM wave and receiving the reflected EM wave. The aerial vehicle 400 may transfer the spiral panoramic image and the output of the ranging sensor to a processor. The processor, which may be onboard the aerial vehicle 400, or external to the aerial vehicle 400, may convert the spiral panoramic image into a three-dimensional visual model, with the aid of the ranging sensor measurements.

FIG. 4B illustrates the method of FIG. 4A, with a top view 400B of the shaft 440. While the figures depict the shaft 440 as being cylindrical in shape, it should be understood that the method is applicable for shafts of other shapes and geometry.

According to various embodiments, the aerial vehicle 400 may fly in a spiral path around the depthwise axis of the shaft 440, instead of spin about the Z axis 140. This may be especially applicable if the aerial vehicle 400 is a fixed wing aerial vehicle, like the aerial vehicle 200.

FIG. 5 illustrates an implementation of the aerial vehicle 100 according to various embodiments. The airframe may include a central member 104, also referred herein as the backbone of the airframe. The central member 104 may be a single carbon fiber tube. The central member 104 may be connected to four arms 106, to form a dual Y-shaped airframe. The central member 104 may be an elongated structure, for example a hollow tube, for example a carbon fiber tube. The central member 104 may be elongated along the longitudinal axis 120. Each arm 106 may also be a straight elongated structure, fabricated out of a similar material as the central member 104. The arms 106 may be arranged symmetrically about the longitudinal axis 120. Each arm 106 may have a first end connected to the central member 104, and may have an opposing second end terminated with a propeller guard 510. The second end may be separated from the central member 104. A distance between the first end and the camera 110 along the longitudinal axis 120 may be smaller than a distance between the second end and the camera along the longitudinal axis 120. The propulsion means of the aerial vehicle 100 may include at least one rotor 108 coupled to each arm 106. Each rotor 108 may include a propeller blade 532 and a motor 530, for example a brushless motor, for spinning the propeller blade 532. The propeller blade 532, also referred herein as propeller, may be arranged to spin about a propeller axis that is at least substantially orthogonal to the longitudinal axis 120. The central member 104 may be hollow for carrying payloads, electrical wiring and processors. All electrical wirings of the aerial vehicle 100 may be routed through the central member 104 to prevent occlusion to the FOV of the camera 110. A controller 516 may be arranged in the central member 104. The controller 516 may be a flight controller that is configured to process sensor readings and to control the flight of the aerial vehicle 100. The controller 516 may also control the data communications of the aerial vehicle 100, for example via the telemetry link 516 and a video link 508. The telemetry link 516 may transmit to and receive telemetry data from a computing device that is external to the aerial vehicle 100. The video link 508 may transmit payload data, including imagery captured by the camera system 102 to the computing device that is external to the aerial vehicle 100. The video link 508 may optionally be built into the camera system 102. The central member 104 may also house the camera system 102. The camera system 102 may include a camera 110 which may be a high definition camera. The camera system 102 may further include light emitting diodes to provide illumination for the camera 110 to record images in dark environments. The camera system 102 may also include a range sensor, which may be time-of-flight (ToF) sensors. The range sensor of the camera system 102 may provide distance measurements for correlating its captured images of a covered infrastructure, with the geometry of the covered infrastructure. The camera system 102 may include a rotary actuator, also referred herein as a gimbal. The rotary actuator may be coupled to the camera 110, so as to spin the camera 110. The rotary actuator may be rotatable through 360° about the longitudinal axis 120. The central member 104 may be at least partially transparent. The central member may at least partially surround the camera system 102 with a panoramic glass enclosure 512 such that the camera 110 may always face the glass enclosure 512 even as it rotates through 360°. The glass enclosure 512 may be at least substantially transparent so that the camera 110 may capture images outside of the central member 104. The aerial vehicle 100 may include an array of range sensors 502. The range sensors may be coupled to external surfaces of the airframe, for example, at the front, rear, and sides of the airframe. The range sensors 502 which may be infrared ToF sensors, may provide distance measurements to the controller 516. The distance measurements may be measurements of a distance between the camera 110 and a nearest surface from the camera 110. The controller 516 may determine the location and orientation of the aerial vehicle 100 based on the measurements from the range sensors 502. The airframe may be designed to prevent occlusion of the field-of-view (FOV) of the camera 110 by the propellers 532 and other functional on-board components. The arms 106, the propeller guards 510 and the propellers 532 may be offset from the camera 110, in particular along the longitudinal axis. The arms 106, the propeller guards 510 and the propellers 532 may be positioned such that they do not obstruct the field-of-view of the camera 110. The aerial vehicle 100 may include lithium-ion batteries with high energy density to achieve long endurance.

Optionally, the aerial vehicle 100 may include an optical flow sensor 514 to aid in obstacle avoidance and localization within the covered infrastructure. The aerial vehicle 100 may also include a front operator camera 522, for an operator of the aerial vehicle 100 to see where the aerial vehicle 100 is heading during flight. The aerial vehicle 100 may include a fine-tuned propulsion system which allows for maximum cooling of both the motors and the electronic speed controllers. The aerial vehicle 100 may be manually piloted semi-autonomously using long range radio and video transmission systems. In cases where manual control is not necessary or not possible, the aerial vehicle may make autonomous flights using pre-planned paths which may be stored in the controller 516.

In addition to the above-mentioned sensors and components, the UAV can also carry an array of environmental sensors that measure the immediate environmental conditions such as temperature and pressure. The array of environmental sensors may also include integrated hazardous gas sensor 520 that detect or measure the concentration of specific gases. If a dangerous operating environment is detected, the UAV can be programmed to return to home in a low-power state.

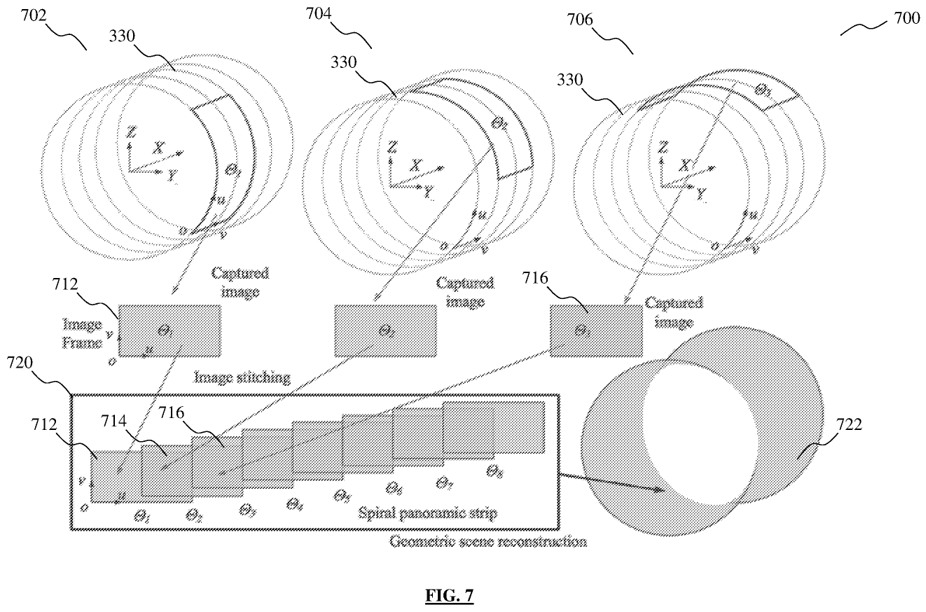

FIG. 6 shows a diagram of a revolving camera system 600 according to various embodiments. The revolving camera system 600 may include, or may be part of, the camera system 102. The revolving camera system 600 may include a camera 110 and a mechanical rotating gimbal 620. The gimbal 620 may be rotatable through a full revolution. The camera 110 may be affixed to the gimbal 620. A ranging sensor, referred herein as ToF sensor 602, may be coupled to the gimbal 620, in close proximity to the camera 110. The gimbal 620 may include a motor 606 and a set of gearing 610. The motor 606 may operate to rotate a first gearing wheel 610a of the set of gearing, and the first gearing wheel 610a may interlock with a second gearing wheel 610b such that rotation of the first gearing wheel 610a causes the second gearing wheel 610b to also rotate. The second gearing wheel 610b may be larger in diameter, as compared to the first gearing wheel 610a. The gimbal 620 may include an opening, for example, through its centre of gravity. The gimbal 620 may be mounted to the central member 104 by having the opening receive the central member 104. Electrical wirings of the revolving camera system 600 may be arranged within the hollow core of the central member 104 and within the opening. The revolving camera system 600 may include its own battery 604 that may independently power its camera 110, motor 606 and ToF sensor 602. The revolving camera system 600 may further include an image transmission unit 608. The image transmission unit 608 may transfer imagery or video captured by the camera 110, to a processor onboard the aerial vehicle via the electrical wiring 612. Additionally, or alternatively, the image transmission unit 608 may include a wireless transmitter to transmit the imagery or video to a computing device external to the aerial vehicle. The revolving camera system 600 may enable high-resolution imaging with minimal optical distortion. The images captured by the camera 110 may be stitched offline for the visual inspection of the imaged surface. The processor on the aerial vehicle may control the rotation speed of the gimbal 620 based on a velocity of the aerial vehicle. The gimbal 620 may spin the camera 110 in a controlled manner, taking images of the covered infrastructure inner surface as the aerial vehicle moves forward. The result may be a sequence of spiral panoramic images. These images may be stored locally in the revolving camera system 600, or may be stored in a storage unit in the aerial vehicle. These images may be transmitted to a ground station. The revolving system 600 may include multiple cameras 110 depending on the translational speed required for the aerial vehicle, the rotational speed of the gimbal 620, and the overall quality of the captured image. The aerial vehicle may also include more than one revolving camera system 600.

FIG. 7 shows a diagram 700 that illustrates a method of mapping a tunnel according to various embodiments. As the aerial vehicle 400 travels through the tunnel 330, its camera 110 may take successive images of the interior of the tunnel 330 as the gimbal rotates with a known fixed angle interval. Using known aerial vehicle translational speed, gimbal rotational speed, and distance from camera to wall, a panoramic image may be stitched. Sub-diagrams 702, 704 and 704 represent sequential time instances of the aerial vehicle 400 imaging the tunnel 330 as the aerial vehicle 400 travels through the tunnel 330 along the X-axis of the tunnel 330. In sub-diagram 702, the camera 110 of the aerial vehicle 400 images an area θ₁ 712. Area θ₁ 712 may be part of an inner wall of the tunnel 330. The size of area θ₁ 712 may be determined by at least one of the angular position of the camera 110, the distance measured from the ranging sensor of the camera system 102, the flight velocity v of the aerial vehicle 400 and the rotational speed u of the camera 110. Next, in sub-diagram 704, the camera 110 has rotated to another position and may image an area θ₂ 714. Next, in sub-diagram 706, the camera 110 has rotated to another position and may image an area θ₃ 716. The camera system 102 may transmit each of images of areas 712, 714 and 716 to a processor that may be onboard or in a ground control station. The processor may stitch the images together to form a spiral panoramic strip 720 and may further “roll” or construct a three-dimensional model 722 based on the spiral panoramic strip 720. In forming the three-dimensional model, the processor may rely on the readings from the ranging sensor of the camera system 102, the flight velocity v of the aerial vehicle 400, and the rotational speed u of the camera 110, to correlate each imaged area to a particular position in the tunnel 330.

The main challenges of autonomously navigating in the tunnel environments using aerial robots is the problem of localization in pitch-black GPS-denied environments, and the development of an energy-efficient aerial platform and sensing methodology to perform extended hours of inspection in long tunnels.

According to various embodiments, an aerial vehicle may employ a sparse sensing system for obstacle avoidance and localization in tunnels and shafts, to address the abovementioned challenges. The sparse sensing system may be lightweight and energy efficient so that the aerial vehicle may have a high payload capacity and may have a long endurance. The sparse sensing system may require prior knowledge of the tunnel geometry and may perform well in tunnel environments that are relatively featureless, especially so under poor illumination.

The sparse sensing system may include an array of ranging sensors (for example: ToF sensors) mounted on the aerial vehicle. Depending the on the environment, there may be an optimal sensor configuration that may enable localization with the lowest degree of errors. The optimal configuration may be mathematically formulated as a spatial optimization problem with constraints such as preventing occlusion to the rotating camera field-of-view and the feasibility for mechanical implementation on the aerial vehicle.

In the following, the design optimization of the sparse sensing system is described in detail.

The localization approach employed on the aerial vehicle may rely on the knowledge of the geometry of the tunnel, and may be formulated using parametric representation of the known geometry. The position of the robot may be estimated based on the sparse array of rangefinders. Analytically, there exists a sub-optimal placement of the sensors in the geometrical blindspot of the environment. For instance, assuming the front of the robot is aligned with the longitudinal axis of the tunnel and all sensors are placed pointing directly in front and behind the robot, pose estimation may not be possible when the robot is rotated in the yaw axis such that the sensors are not within range of the tunnel walls. A design optimization is formulated to search for an optimal spatial configuration of the sensors in both tunnel and shafts results in low error tracking of the robot pose. To tackle the large search space, genetic algorithm (GA) is used to solve the optimization problem.

Notation

Frames are denoted with italic fonts, e.g. A, with the unit vectors {\hat{x}^{A}, ŷ^{A}, \hat{z}^{A}} and origin O^{A}. The local frame, L, may be defined with \hat{x}^{L} parallel to the longitudinal axis of the tunnel, and \hat{z}^{L} defined parallel to the gravity vector, and ŷ^{L} such that \hat{x}^{L}×ŷ^{L}=\hat{z}^{L}. B may be a body-fixed frame with \hat{x}^{B} pointing to the front of the robot, \hat{z}^{B} down and ŷ^{B} such that \hat{x}^{B}×ŷ^{B}=\hat{z}^{B}. The origin O^{B} is attached to the geometric centre of the robot. A rotation matrix ^{L}R_{B} transforms a point in frame B into L. The full state of the craft is defined in the local frame as

r^{L}=[x y z ϕₓ ϕ_{y} ϕ_{z}]^{L,T} (1)

Environmental Assumptions

Tunnel environments may refer to structured environment with high reflection symmetry, a characteristic prevalent in man-made structures, e.g. canal, penstocks, sewerage tunnel, shafts and etc. These structures are uni-axial with a known cross-sectional parametric representation, and visually-degraded with poor illumination. In particular, the following description focuses on navigating a horizontal tunnel with a rectangular cross-section and vertically descending a cylindrical shaft with circular cross-section although it should be understood that the aerial vehicle may not be limited to navigating tunnels and shafts of such geometries. Due to the lack of salient geometric landmarks and the symmetry of the environment, there are inherent “blind spots” that prohibits the reliable estimation of the position of the robot along the tunnel axis solely from the sparse array of rangefinders.

Perception Algorithm

Based on prior knowledge of the geometry of the environment, the perception algorithm translates the range input from the sparse sensing array into reduced-order pose estimates in the tunnel. It involves first finding a suitable cross-section of the tunnel that maximizes the number of robot states that can be estimated, and subsequently deriving a parametric representation for the chosen cross-section of the tunnel. For horizontal tunnels, the reflection symmetry of the tunnel about local x-z plane makes it possible to only estimating 2 DOF: the lateral position offset, y^{L}, and the yaw, ϕ^{L}, of the robot. For traversing in vertical shafts, the axial symmetry about the z^{L} allows for only 2 DOF pose estimates: the lateral position displacement, x^{L} and y^{L}. In both cases, the position along the longitudinal axis of the tunnel, i.e. x^{L} in the horizontal tunnels and z^{L} in the vertical shaft, is not possible to be estimated from the sparse sensing array, and is left controlled by the operator. The remaining states are estimated with information from the on-board IMU and a downward-pointing rangefinder. The sparse sensing array is populated with rangefinders that have physical range limitations, the minimum and maximum range is denoted by rₘᵢₙ and rₘₐₓ respectively. These limits can either be retrieved from manufacturer technical specifications or empirically determined. The range measurement from a sensor is along the \hat{x}^{S}-axis, where S is the sensor frame with the origin attached to the body of the sensor. The individual measurements are rotated to the body frame, B. The resulting point cloud of the range measurements from the sparse sensing array in B is denoted as p^{B}∈ [symbol] ^{M×1} where M is the number of sensors in the array. Using linear least square approach, the point cloud, p^{B}, is used to estimate the parameters for the parametric representation of the tunnel. The parameter fitting procedure for tunnel environments is discussed first, followed by vertical shaft environments. Unless otherwise stated, the proceeding calculations are performed in frame B.

Pose Estimation in Tunnel Environments

Most man-made tunnels have local sections with right rectangular prism geometry, bounded by vertically parallel walls on two sides, water body on the bottom, and a ceiling on the top. In addition, all angles are right angles. This justifies the reduction of the geometry to a 2D planar form, formed by intersecting the geometry with a local x^{L}-y^{L} plane.

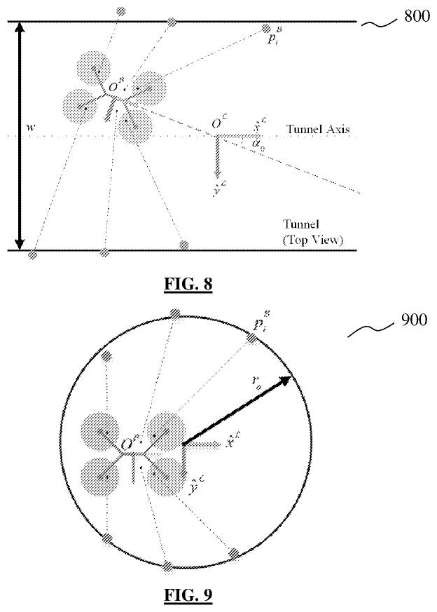

FIG. 8 shows a planar cross-section 800 with two parallel lines which is the geometry of a tunnel reduced to a 2D planar form. The Hesse normal form is used to parametrically represent the line as

ρ₀=x cos α₀+y sin α₀ (2)

where ρ₀ is the perpendicular distance from the O^{B} to the line, α₀ is the slope of line in a bounded interval (−π, π], given by the angle the line makes with x^{B}, and x and y are coordinates of the feasible set that falls on the line. The feasible set contains the range measurements from the sparse sensing array, where p_{i,x}=pᵢ·\hat{x}^{B}, p_{i,y}=pᵢ·ŷ^{B} and pᵢ is the measurement of the i-th rangefinder projected onto the local x^{L}-y^{L} plane.

The distance and slope parameters can be determined from the linear regression formulation as shown in below

$$\begin{matrix}\begin{matrix}b = Af & f = {( {A}^{T} A )}^{- 1} {A}^{T} b\end{matrix} & ( 3 ) \\ and & \\ \begin{matrix}A = W [ \begin{matrix}- {p}_{x}^{l} & - 1 & 0 \\ - {r}_{x}^{r} & 0 & - 1\end{matrix} ] & b = W [ \begin{matrix}{p}_{y}^{l} \\ {p}_{y}^{r}\end{matrix} ]\end{matrix} & ( 4 ) \\ f = {[ \begin{matrix}tanα & {p}_{0}^{l} & {p}_{0}^{r}\end{matrix} ]}^{T} & ( 5 )\end{matrix}$$

where pₓ^{l} and p_{y}^{r} is a column vector of the x and y component of the points that falls on the left and right line tunnel wall respectively, p₀^{l} and p₀^{r} is the perpendicular distance to the left and right wall respectively, α is the slope of the line segments, and W is a diagonal matrix with weights w_{i,i}=e^{-(λp)}^{²} on the diagonal, with λ determined from an optimization algorithm that will be discussed in subsequent paragraphs.

In the above formulation, the tunnel walls are assumed to be parallel, which is highly accurate of canal environments that exhibit reflection symmetry about the local x-z plane. The partial pose of the robot in the tunnel is then given by

$$\begin{matrix}\tilde{r} = {[ \begin{matrix}x & {ϕ}_{z}\end{matrix} ]}^{T} & ( 6 ) \\ and & \\ \begin{matrix}x = \frac{w}{2} + {f}_{3} & {ϕ}_{z} = {tan}^{- 1} {f}_{1}\end{matrix} & ( 7 )\end{matrix}$$

and w is the estimated width of the tunnel and is given by w=½(f₂+f₃).

However, to construct the A matrix in (4), there is a need to determine which rangefinder in the sensing array measured the left and the right tunnel wall, given by \vec{p}ₓ^{l} and \vec{p}_{y}^{r} respectively. Equation (2) can be rewritten as

ρ⁻¹=ρ₀⁻¹ cos(θ−α₀) (8)

where ρ is the expected sensor measurements if placed with orientation θ given that the perpendicular distance, ρ₀, from the origin and slope, α₀.

Equation (2) does not accurately reflect the physical sensor model as the rangefinders have limited range, and does not output negative range. A more accurate representation would be

$${ρ}^{- 1} = \{ \begin{matrix}{ρ}^{- 1} , & for {r}_{min} \leq ρ \leq {r}_{max} \\ 0 , & for ρ \leq {r}_{min} or ρ \geq {r}_{max}\end{matrix} \qquad ( 9 )$$

An over-complete dictionary, D, may be defined with the i-column, dᵢ given by

dᵢ=cos(θ−α₁) (10)

where θ is a column vector from

$$[ - \frac{π}{2} , \frac{π}{2} ]$$

with discretization Δθ, and αᵢ⊂[−π,π] with discrete interval Δα.

The set of points from the sparse sensing array that falls on the left or right tunnel surface can be found by solving the following optimization problem

min∥W(p−Ds)∥₂² subject to ∥s∥₀≤N (11)

where W is a diagonal matrix with weights w_{i,i}=e^{(λpi)}^{²} on the diagonal, with A from the optimization output, s is a N-sparse column vector with at most N non-zero elements.

The minimization problem defined (11) is a known NP-hard problem. However, such problems are well-explored in compressing sensing literature, and various approximation methods are widely used. The method of matching pursuit (MP) may be used to find the a N-sparse approximation to the problem. The solution is denoted as s*. Then, the points that fall on the same tunnel wall are given by the index set, S, of the non-zero entries of Ds*, i.e.

S⊂supp(Ds*)={i⊂{1, . . . ,n}:Dsᵢ*≠0} (12)

Let p_{S} denote the submatrix of p containing only the elements with index in S and p_{S̅} is the set of entries of p that are not in the set S. Currently, the points are segmented into two sets, p_{S} and p_{S̅}, but it is still not known which sets belongs to the left or the right tunnel walls. The notation defined earlier may be used to resolve this final issue. Let p^{l}=p_{S} and p^{r}=p_{S̅}, and using the linear regression formulation in (4)-(5), the resultant f vector in (5) should result in f₃=p₀^{r}≥0 and f₂=p₀^{l}≤0. If the converse is true, then p_{S}=p^{r} and p_{S̅}=p^{l} instead.

Pose Estimation in Vertical Shaft Environments

As vertical shafts are cylindrical, this reduces the problem to a 2D form, by intersecting the geometry with a local x-y plane.

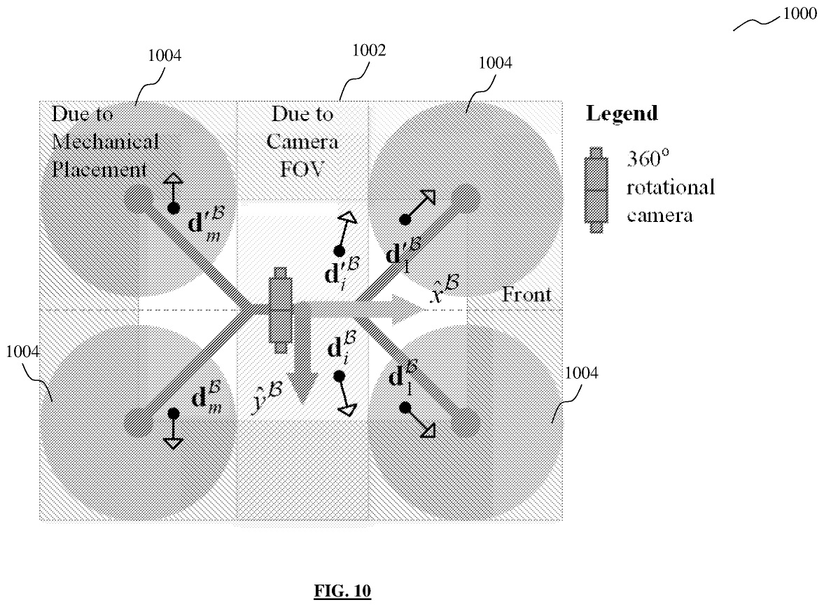

FIG. 9 shows a circular cross-section 900 which is the geometry of a vertical shaft reduced to a 2D form. The parametric representation of the circle is given as

r₀²=(x−x₀)²+(y−y₀)² (13)

where (x₀, y₀) is the centre of the circle in frame [symbol] , and r₀ is the radius of the circle.

Similarly, the parameters can be estimated by the least square formulation to fit the sensor measurements to the parametric representation

A=[2pₓ 2p_{y} 1] b=[pₓ²+p_{y}²] (14)

f=[x₀ y₀ x₀²+y₀²+r₀²]^{T} (15)

Then, the local position of the robot within the vertical shaft is

[symbol]

= [symbol] =−[f₁,f₂] (16)

The radius of the shaft can also be determined as

r₀=\sqrt{f₃−(f₁²+f₂²)} (17)

Design Optimization of Sparse Sensing Array

FIGS. 8 to 9 illustrate the planar position estimation for an aerial vehicle that is traversing a cylindrical shaft vertically and right rectangular prism tunnel horizontally. A planar configuration may be sufficient to estimate the planar position (x and y) of the aerial vehicle in the environment. In this scenario, the sensor inputs are used to fit a circle and a pair of parallel lines for the shaft and tunnel navigation respectively, to estimate the position of the aerial vehicle in the environment. However, these geometries can be generic depending on the geometry of the tunnel, and is not constrained to cylindrical shafts and right rectangular prism tunnels. For a robust estimation of 3D position (x, y, and z) in 3D space, it is necessary for the sensors to be placed in more than one plane. The algorithm for estimating the position of the aerial vehicle is similar to the 2D case, the measurements from the sensor input are used to fit a parametric representation of the known geometry of the tunnel.

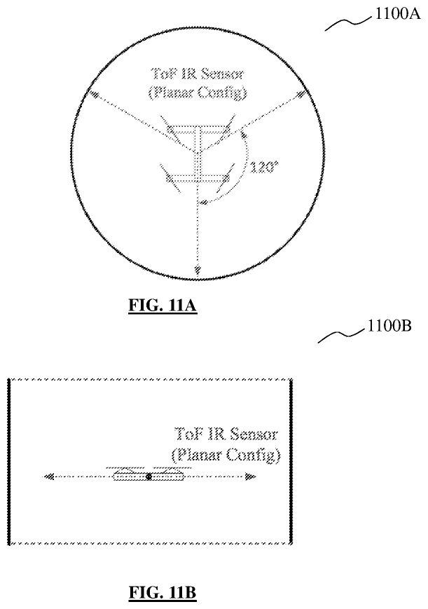

FIG. 10 shows a visual illustration 1000 of the optimization problem in formulated in 2D, where the sensor placements and the spatial constraints are illustrated in a 2D plane. The optimization variables are illustrated in the body frame of an aerial vehicle. The algorithm optimizes the spatial position and orientation of m sensors mounted on the right half plane of the aerial vehicle. The infeasible region for placement of the sensors due to the camera FOV 1002 and mechanical placement 1004 are shown. The optimization variables are illustrated in the body frame of the aerial robot. The algorithm optimizes the spatial position and orientation of m sensors mounted on the right half plane of the craft. The infeasible region for placement of the sensors due to the camera FOV (blue) and mechanical placement (red) are shown. There are a total of m₀ sensors on the robot. The optimization changes the mounting positions [symbol] and mounting orientations [symbol] for all the m₀ sensors. It is assumed that the sensors are mounted symmetrically on the robot, and [symbol] is the line of symmetry. This assumption is valid due to the reflection symmetry of tunnel environments. Hence, the optimization explores a (3×m)-dimension

$$( where = \frac{{m}_{0}}{2} ) ,$$

for the placement of the sensors on the right-hand plane of the robot. The optimal sensor configuration is optimized for a certain range of tunnel parameters γ i.e. γᵢ corresponds to w, α of a tunnel or r of a shaft. For a sampled tunnel parameter γᵢ, sensor readings from a set of robot pose η within the tunnel are also simulated. The sensor noise is simulated as a random Gaussian distribution centered at. To evaluate the performance of a sensor configuration, the root mean square (rms) error E, is used. E is defined as

$$E = \frac{1}{N \times M} {\sum }_{i = 1}^{N} {\sum }_{j = 1}^{M} ( {\tilde{r}}_{i , j} - {\tilde{r}}_{i , j}^{*} ) {( {\tilde{r}}_{i , j} - {\tilde{r}}_{i , j}^{*} )}^{T} \qquad ( 18 )$$

where \tilde{r} denotes the estimated position of the robot (6) and (16) calculated from the simulated sensors, and \tilde{r}* is the ground truth position the robot. The subscript i,j denotes that pose was estimated from simulated sensor readings in tunnel parameter γᵢ, and robot pose ηⱼ. In this formulation, the errors across all the robot states are equally weighted i.e. 1 rad error in yaw estimation is equivalent to 1 m displacement error in the tunnel.

Then, the optimal sensor placement can be obtained by minimizing the error function E, or

min_{d,Θ,λ}E where d∈D={x∈ [symbol] ^{m}:g(d)≤0} (19)

where g is a logarithmic barrier function that penalizes the placement of the sensors near the constraint bounds. The design optimization also solves for the optimal λ, a parameter for the radial weighting function used in the weighted least squares, and the minimization problem in (11).

There are physical constraints on the robot that limits the feasible region for the placement of the sensors. In the case of aerial robots designed for visual inspection of the entire tunnel surface, the sensor cannot be placed within the field of view (FOV) of the camera, and the sensors need to be reasonably close to the mechanical components of the robot for the ease of mounting and electrical wiring. These physical bounds can be described mathematically by a generic user-defined function. For simplicity, the infeasible region due to the camera FOV is defined as a rectangle given by ∥x∥<xₘᵢₙ and region due to mechanical placement is defined as the area outside the bounding box with the corners fixed on the centre of each propulsion system i.e. ∥x∥>xₘₐₓ∪∥y∥>yₘₐₓ. The infeasible regions are also illustrated in FIG. 10.

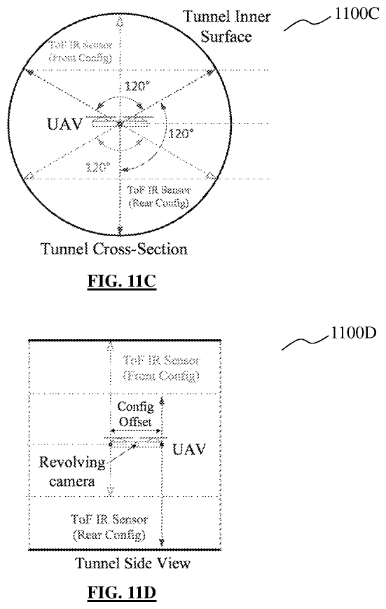

FIGS. 11A-11D shows possible, but not limiting configurations of the sparse array sensors according to various embodiments.

FIG. 11A shows a top view 1100A of a planar configuration of the sparse array sensors for vertical navigation along a cylindrical shaft. In the planar configuration, the ToF sensors may be mounted on the top-down plane. The ToF sensors may be arranged to detect the lateral side walls in vertical ascending and descending flights within covered infrastructure.

FIG. 11B shows a depthwise cross-sectional view 1100B of the cylindrical shaft with an aerial vehicle fitted with the planar configuration of the sparse array sensors.

FIG. 11C shows a front cross-sectional view 1100C of a tunnel with an aerial vehicle fitted with the front/rear configuration of sparse array sensors. In the rear configuration, the ToF sensors may be mounted on the front-back plane. The front and rear configurations may feature ToF sensors that detect the cross-section of the covered infrastructure in forward and reverse flight.

FIG. 11D shows a side cross-sectional view 1100D of a tunnel with an aerial vehicle fitted with the front/rear configuration of sparse array sensors.

The ToF sensors for the planar and front/rear configuration may overlap to reduce the total number of ToF sensors required. The ToF sensors may be complemented by optical flow sensors that are used for localization along the tunnel axis, and may also be complemented with a downward pointing laser altimeter for measuring the altitude of the UAV within the covered infrastructure. The downward pointing laser altimeter may or may be not part of the rear configuration.

Optimization Using Genetic Algorithm

Genetic algorithm (GA) is a nature-inspired evolutionary algorithm that uses mutation, crossovers and selection to yield high-quality solutions for large optimization problems. In this case, the design optimization presented involves a large combinatorial search over a (3×m)-dimension space for the optimal sensor configuration that minimizes the rms error E. GA tackles the large search space by the discretizing the space into nodes where each node is a possible location to mount the sensors. During the search, each candidate solution is coded into a gene, which contains the optimization variables d, Θ and λ. The rms error E is directly used to evaluate the fitness of a particular gene. In each generation, a group of elites with the best fitness is guaranteed to survive next generations. The remaining genes are used to breed the next generations of candidate solutions, known as children, through crossover and mutation. The algorithm is allowed to evolve over many generations until the average change in the best fitness of the population stalls over a user-defined number of generations. The gene with the best fitness in the final generation is the optimal solution to the optimization problem.

Numerical Results

A numerical simulation was conducted and the rms error E was studied for m=2, 3 and 4 configuration, corresponding to the layout of m₀=4, 6 and 8 sensors on the robot. The optimal configuration from the GA and the parameters used for the numerical simulation are shown in Table I.

TABLE I
RESULTS OF THE OPTIMAL SENSOR CONFIGURATION

| optimal | (M2) m = 2 | (M3) m = 3 | (M4) m = 4 |
|---|---|---|---|
| d₁,\hat{d}₁ | 0.525, 69.7° | 0.49, 53.6 | 0.315, 75.7° |
| θ₁ | 1.5° | 32.6 | 76.7° |
| d₂,\hat{d}₂ | 0.49, −78.7° | 0.49, 43.6 | 0.49, 55.7° |
| θ₂ | −2.5° | 2.5 | 13.54° |
| d₃,\hat{d}₃ | — | 0.46, −35.6 | 0.42, −50.6° |
| θ₃ | — | −35.6 | −10.53° |
| d₄,\hat{d}₄ | — | — | 0.385, −71.7° |
| θ₄ | — | — | −71.7° |
| E | 0.058 m | 0.030 m | 0.021 m |
| constraint parameters | | sensor parameters | |
| xₘᵢₙ = 0, xₘₐₓ = 0.38 | | rₘᵢₙ = 0.3, rₘₐₓ = 14.0 | |
| yₘᵢₙ = 0, yₘₐₓ = 0.5 | | [symbol] = 0.05 | |
| tunnel parameters | | | |
| $\frac{w}{2} min = 2 , \frac{w}{2} max = 2$ | | r_{0,min} = 2, r_{0,max} = 3.6 | |
| $\vert {\tilde{r}}_{ϕ} \text{?} \vert \leq 60 ° , \vert {\tilde{r}}_{y} \vert \leq \frac{w}{2} - 1$ | | \|\tilde{r}\| ≤ r₀ − 1 | |
| sub-optimal | (M2′) m = 2 | (M3′) m = 3 | (M4′) m = 4 |
| d₁,\hat{d}₁ | 0.525, 69.7° | 0.49, 53.6 | 0.315, 75.7° |
| θ₁ | 25° | 50 | 50° |
| d₂,\hat{d}₂ | 0.49, −78.7° | 0.49, 43.6 | 0.49, 55.7° |
| θ₂ | 0° | 25 | 25° |
| d₃,\hat{d}₃ | — | 0.46, −35.6 | 0.42, −50.6° |
| θ₃ | — | 0 | −25° |
| d₄,\hat{d}₄ | — | — | 0.385, −71.7° |
| θ₄ | — | — | −50° |
| E | 1.189 m | 1.5088 m | 0.804 m |

[symbol]

indicates data missing or illegible when filed

In all cases, the best and mean penalty value and the average distance between individual converges, indicating that an optimal solution is found.

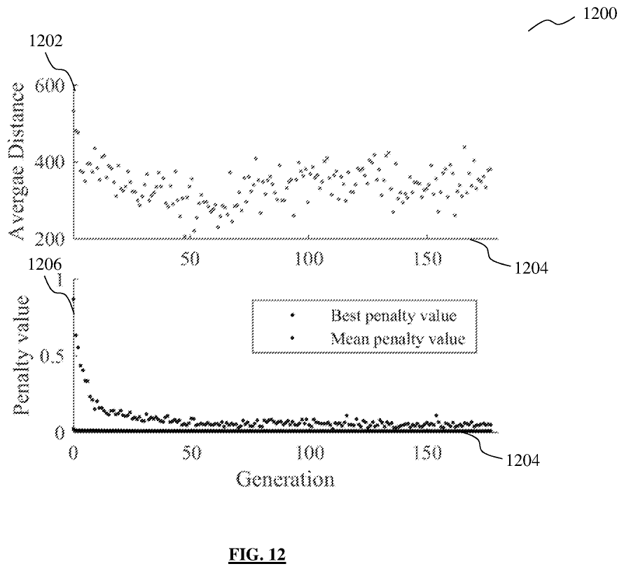

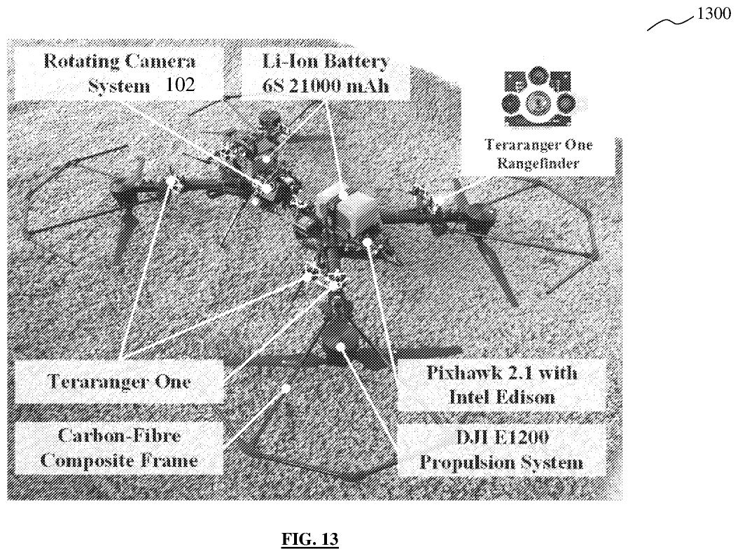

FIG. 12 shows graphs 1200A and 1200B that illustrate the results of the numerical simulation. The graph 1200A includes a vertical axis 1202 indicating average distance, and a horizontal axis 1204 indicating the number of generations. The graph 1200A shows the average distance between individual converges in 180 generations for the m=3 optimization. The graph 1200B includes a vertical axis 1206 indicating penalty value, and a horizontal axis 1204 indicating the number of generations. The graph 1200B shows that the mean penalty value and the best penalty value converges in 180 generations for the m=3 optimization. The average fitness of the best penalty value stalled after 180 generations. The best and mean penalty of the final population is 0.00763 and 0.0488 respectively.

The optimal configuration output from GA have good localization performance of rms error E of at least 0.06 (the E for M2 configuration). The rms error improves with the increase in sensor count, M3 and M4 have lower E. Increasing m=2 to m=3 results to a significant two-fold reduction of the rms error from 0.058 m to 0.03 m. Further increment m=4 reduces the rms error but this time, the reduction is not as significant.

There may be an intuitive explanation for the GA results for M2. M2 configuration have the sensors pointing to the immediate left and right of the robot. This would ensure that the range measurement of the rangefinder would remains within range throughout the simulated yaw range of ±60° at various pose within the tunnel. The GA results for M3 and M4 are more challenging to find an intuitive explanation. The results from the GA are compared to sensor configurations that are placed heuristically. These configurations always results in a optimal E. Inspired by M2, M2′ have one sensor pointing 25° forward and the other pointing at 0°, the immediate right. M2′ have a high E of 1.189 and a reduced yaw range of ±30°. M4′ have configuration with sensor pointing at 25° interval. The resultant E is 0.804, and a reduced yaw range of ±40° which is worse than the M4. M6′ have a E of 1.51 m and a reduced yaw range of ±40°. The placement of the sensors in the sparse sensing array through heuristics or trial and error is a challenging one. On average, the rms error of the GA is at least 36 times better than the suboptimal configurations and is shown to be extremely powerful in producing a optimal sensor configuration with minimal E.

Experimental Results

A series of four experiments were performed to evaluate the performance of the optimal sensing configuration with the proposed pose estimation to autonomously navigate tunnel environments. In these experiments, when the robot was autonomously flight tested, the pilot only commanded the position of the robot along the longitudinal axis of the tunnel i.e. along [symbol] -direction in horizontal tunnel environments and [symbol] -direction in vertical shaft environments. The remaining DOF are controlled by the on-board controller. The experiments in the horizontal tunnel are discussed first, followed by those performed in the vertical shaft.

Prototype Platform

FIG. 13 shows a photo of a prototype 1300 of the aerial vehicle used in the experiments. The prototype 1300 may be representative of the aerial vehicle according to various embodiments. The prototype 1300 includes the rotating camera system 102, the lean sensing system, lithium-ion battery, and fine-tuned powertrain integrated on the aerial vehicle platform. Data was collected from experiments done in actual tunnels and shafts. The endurance of the prototype was also tested in lab environment.

The visual inspection system, also referred herein as the camera system 102, may be independent of the aerial platform, supplied with its own battery and microcontroller. As such, all electrical wiring for power and digital signals runs through a centre 25 mm diameter carbon-fibre rod that the visual inspection system rotates about. The carbon-fibre rod may be the central member 104. The arms 106 of the prototype 1300 may also be fabricated out of carbon-fibre composite. The rotor 108, or propulsion system may include a DJI E1200 powertrain. The flight controller 516 may be Pixhawk 2.1 flight controller with built-in IMU, and a Intel Edison as companion computer. The range sensors 502 may include a lightweight array of six TeraRanger One rangefinders, weighing 10 g each. The sensor configuration is a hybrid of the M4 and M6 configuration from the GA result of the numerical simulation. The hybrid allows for a redundancy of the sensing system. For example, if either of the front two rangefinder were to fail, the algorithm can fall back to an algorithm that uses only four rangefinders to continue the navigation mission. The prototype weighs 5 kg, inclusive of the 21000-mAh 6S 10C Li-Ion battery.

Table II shows the breakdown of the weights of the various subsystems. The sparse sensing array and additional companion computer contribute to merely 2.8% of the total weight.

TABLE II
WEIGHT DISTRIBUTION OF SWIRL

| Subsystem | Weight (g) | Weight (%) |
|---|---|---|
| Mechanical Frame^{a} | 828 | 16.0 |
| Powertrain | 1380 | 27.6 |
| Visual Inspection System | 372 | 8.0 |
| Flight Avionics^{b} | 100 | 2.0 |
| Battery | 1750 | 35.0 |
| Sensing Array | 110 | 2.2 |
| Companion Computer | 30 | 0.6 |
| Total | 5000 | 100 |

^{a}includes the weights of the power electronics and wirings,
^{b}includes the associated accessories e.g. compass, power modules, and etc.

Table III shows that compared to similar UAVs documented in academic literature, the sparse sensing system is on average 5 times lighter and consumes 12 times less power. The lean and low-power sensing system, as a result, enables the prototype to achieve 35 mins of autonomous flight. The total weight of the proposed system is at least quarter of conventional system and at least a ten-fold reduction in power consumption. These savings directly translate into improved flight endurance of the proposed platform.

TABLE III
COMPARISON BETWEEN SENSING SYSTEMS

| No. | Payload | Weight (g) | Power (W) |
|---|---|---|---|
| 1 | Velodyne Puck LITE | 590 | 8 |
| 2 | 2 Hokuyo UST-20LX | 260 | 7.2 |
| 3 | Intel i7 NUC | 290 | 28 |
| 4 | Teraranger Array ^{a} | 60 | 3.6 |
| 5 | Intel Edison ^{a} | 30 | 0.6 |
| | Combination A (1 + 3) ^{[4]} | 850 | 36 |
| | Combination B (2 + 3) ^{[3]} | 550 | 35.2 |
| | SWIRL (4 + 5) | 140 | 2.8 |

^{a} consists of six teraranger one, and a teraranger hub for synchronisation,
^{b} includes the Intel Edison and the essential breakout boards

System Architecture

The proposed perception algorithm described in the earlier sections is implemented on an Intel Edison computer, running a Debian-based Linux distribution. The Edison runs the Robot Operating System (ROS) middleware for low-latency data acquisition, inter-hardware communication, and the high-level processing task. It interfaces to the sparse planar sensing array, a downward-pointing altimeter, and the IMU, and translates these sensory inputs into partial local position estimates within the tunnel. These estimates are fed into the EKF for full state estimates of the robot. A Pixhawk2.1 autopilot running the PX4 flight stack outputs for low-level command for the control of the SWIRL platform, based on the pilot input and the state estimates of the robot.

Autonomous Flight in Tunnels

The first and second experiments were carried out in horizontal tunnels. In these experiments, the pilot manually controls the robot to take-off, and then fly to an initial position, [symbol] , which is roughly aligned to the tunnel axis of the tunnel, i.e \tilde{r}=0. At this point, the pilot toggles to autonomous mode. In this mode, the pilot only retains manual control of the acceleration along the tunnel axis, [symbol] .

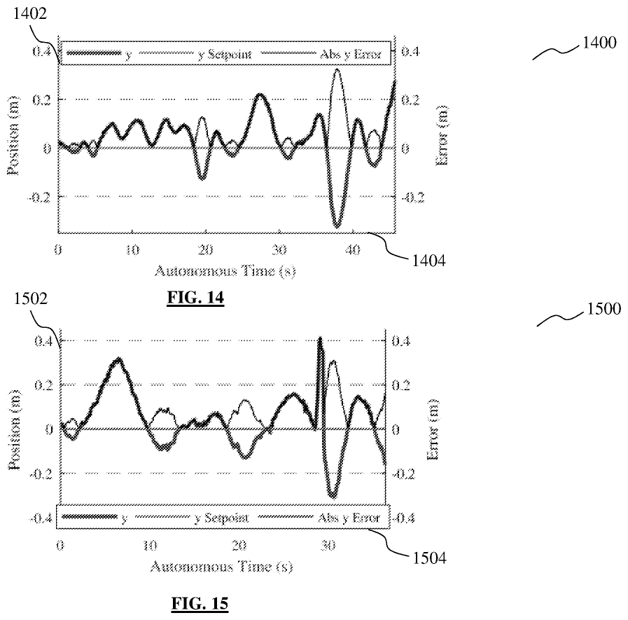

FIG. 14 shows a graph 1400 that plots the result of a first experiment. The first experiment was performed in an indoor mock-up tunnel. The indoor mock-up environment is a corridor approximately 10 m long, 4.2 m wide, and 2.6 m high. The robot flew autonomously for a period of 46 seconds, covering a total distance of 20 m (10 m forward and 10 m back to the initial starting point). The graph 1400 includes a vertical axis 1402 that indicates position in metres, and a horizontal axis 1404 that indicates autonomous time in seconds. The rms position error of the robot was 0.1 m, and the maximum deviation from the centreline was 0.3 m. The fluctuation of the estimates is partially attributed to the presence of protruding aluminum fire extinguisher cabinets on the left side, and permanent structures on the right of the corridor.

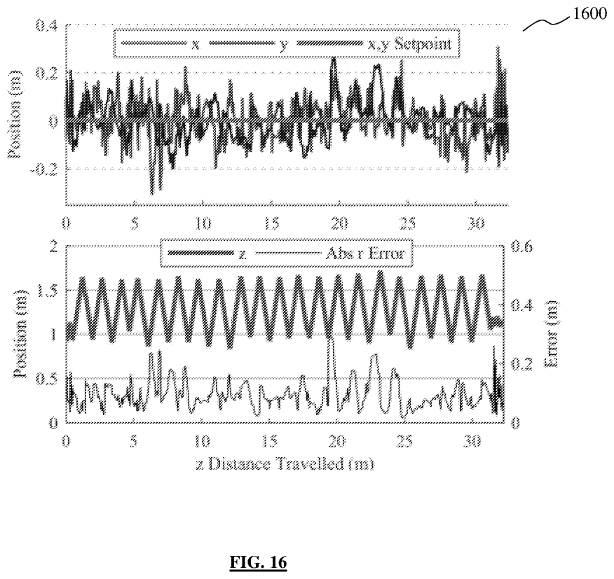

FIG. 15 shows a graph 1500 that plots the result of a second experiment. The second experiment was carried out in a covered section of the Eu Tong Sen Canal, mimicking the poor illumination of the DTSS main tunnel. The tunnel section is approximately 45 m long, 6 m width and 2 m high (measured from the water surface to the top surface). The robot flew autonomously for a period of 36 seconds, travelling a horizontal distance of 45 m. The graph 1500 includes a vertical axis 1502 that indicates position in metres, and a horizontal axis 1504 that indicates autonomous time in seconds. The graph 1500 shows a sudden spike in the position estimates at around 28 s into the autonomous flight due to an unexpected opening on the left side of the canal. The rms position error of the robot was 0.13 m, and the maximum deviation from the centreline was 0.41 m. The errors are comparably close to that of the experiment in the mock-up environment.

Autonomous Flight in Shafts

The goal of the third and fourth experiment was to evaluate the autonomous flight performance in vertical shaft environments. Similar to the previous experiments, the pilot manually controls the robot to take-off, and then fly to an initial position, [symbol] , which is roughly at the centre of the tunnel, i.e. [symbol] =0. At this point, the pilot toggles to autonomous mode. In this mode, the pilot only retains manual control of the acceleration along the tunnel axis, [symbol] .

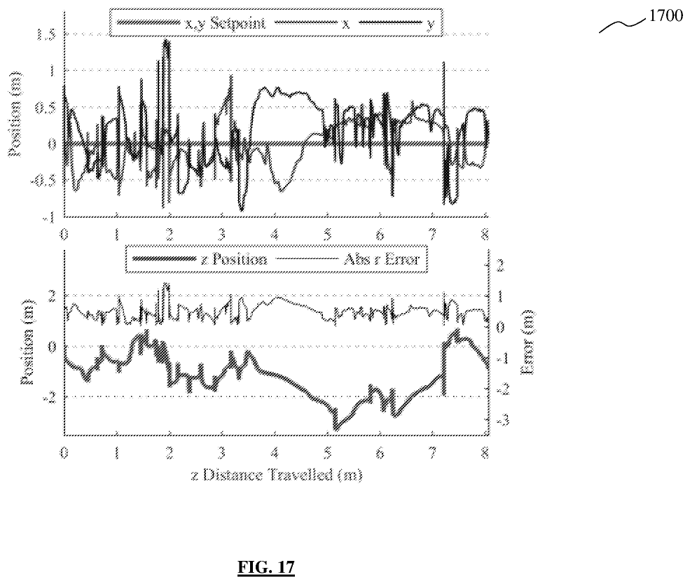

FIG. 16 shows the results of a third experiment. The third experiment was performed in an indoor mock-up of a vertical shaft. The indoor mock-up environment was assembled from curtain hung on a circular ring, creating a cylindrical environment that is similar to the vertical access shaft to the DTSS main tunnel. The mock-up tunnel is approximately 2.4 m high and 2.8 m in diameter. The robot flew autonomously for about 4.5 minutes, travelling a total vertical distance of 32.3 m (21 repetitions of climbing about 0.75 m up and descending 0.75 m down from the initial altitude of 1 m). The rms position error of the robot was 0.11 m, and the maximum deviation from the centreline was 0.32 m.

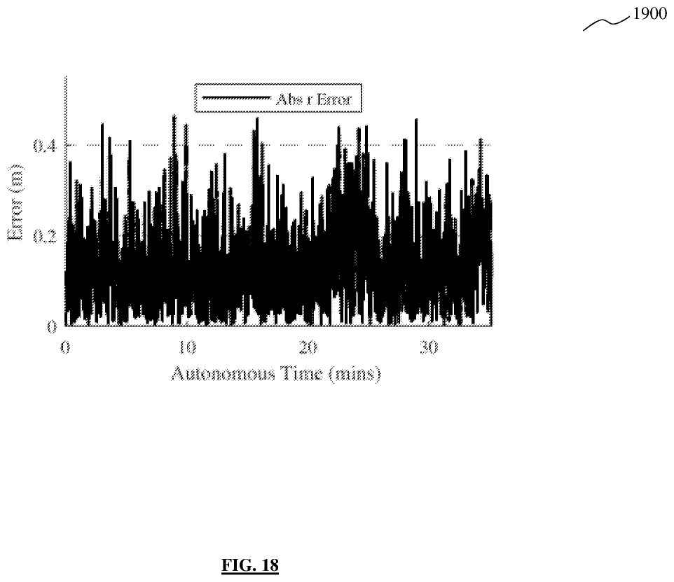

FIG. 17 shows the results of a fourth experiment. The fourth experiment was carried out in a vertical access shaft to the main tunnel of the DTSS. The vertical shaft is approximately 45 m long, with a diameter of about 5 m. In these experiments, the robot is inserted into the shaft through a 1 m manhole opening at ground level. A safety tether was also attached from a winching system at the manhole opening to SWIRL for the insertion of the platform to the 5 m diameter section of the vertical shaft, and for emergency retrieval when necessary. The robot was flown autonomously for about 4.5 minutes and the total vertical distance travelled was approximately 8 m. The opening of the manhole of the vertical access shaft results in the venting of the highly pressurized DTSS tunnel. As a result, there was large volume of high velocity air escaping from this manhole. The measured wind speed at the manhole opening was up to 16 m/s. The constant wind updraft in the shaft causes the robot to oscillate visibly during the autonomous flight. This is coupled with some effects of turbulence when flying in an enclosed environment. The combined effects from the destabilizing wind up-draft and the turbulent environment resulted in a significantly higher rms position error of 0.53 m, and the maximum deviation from the centre of the shaft was recorded at 1.44 m, as compared to the experiment in the indoor mock-up shaft.

Extended Flight in Shaft Environments

Lastly, to evaluate the endurance of the system, the prototype 1300 was tested in an indoor mock-up of the vertical shaft. In this experiment, the robot was commanded to hover at a predetermined height and at the centre of the tunnel. The prototype 1300 achieved a total flight time of 35 minutes and 41 seconds.

FIG. 18 shows a graph 1800 that plots the absolute Euclidean error r throughout the flight. The rms error and max error during the autonomous time was 0.16 m and 0.46 m respectively. While embodiments of the invention have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced. It will be appreciated that common numerals, used in the relevant drawings, refer to components that serve a similar or the same purpose.

It will be appreciated to a person skilled in the art that the terminology used herein is for the purpose of describing various embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. An aerial vehicle comprising:
an airframe comprising a central member defining a longitudinal axis;
a gimbal coupled to the central member;
a camera mounted on the gimbal to face a direction at least substantially orthogonal to the longitudinal axis;
wherein the gimbal is rotatable about the longitudinal axis to spin the camera around the longitudinal axis; and
a propulsion means configured to propel the aerial vehicle, wherein the propulsion means is offset from the camera along the longitudinal axis.

2. The aerial vehicle of claim 1, wherein the airframe further comprises a plurality of arms coupled to the central member, wherein each arm of the plurality of arms is offset from the camera along the longitudinal axis.

3. The aerial vehicle of claim 2, wherein each arm has a first end and a second end opposing the first end, wherein the first end is coupled to the central member and wherein the second end is separated from the central member.

4. The aerial vehicle of claim 3, wherein a distance between the first end and the camera along the longitudinal axis is smaller than a distance between the second end and the camera along the longitudinal axis.

5. The aerial vehicle of claim 2, wherein the propulsion means comprises a respective rotor coupled to each arm, wherein rotor is offset from the camera along the longitudinal axis.

6. The aerial vehicle of claim 5, wherein each rotor comprises a propeller arranged to spin about a propeller axis, wherein the propeller axis is at least substantially orthogonal to the longitudinal axis.

7. The aerial vehicle of claim 2, wherein the airframe comprises four arms arranged symmetrically about the longitudinal axis, wherein the propulsion means comprises four rotors.

8. The aerial vehicle of claim 2, wherein each arm is a straight elongated structure.

9. The aerial vehicle of claim 1, wherein the central member is elongated along the longitudinal axis.

10. The aerial vehicle of claim 1, wherein the gimbal is rotatable through 360° about the longitudinal axis.

11. The aerial vehicle of claim 1, wherein the camera is fixed with respect to the gimbal.

12. The aerial vehicle of claim 1, further comprising a processor configured to control a rotation speed of the gimbal based on a velocity of the aerial vehicle.

13. The aerial vehicle of claim 1, further comprising:
a range sensor coupled to the camera, wherein the range sensor is configured to measure a distance between the camera and a nearest surface from the camera.

14. The aerial vehicle of claim 1, wherein the central member comprises a cavity, wherein the gimbal is housed inside the cavity.

15. The aerial vehicle of claim 14, wherein the central member comprises a transparent window at least substantially longitudinally aligned with the camera.

16. The aerial vehicle of claim 1, wherein the gimbal is configured to rotate continuously as the aerial vehicle is moving at least substantially along the longitudinal axis, such that the camera captures a spiral panoramic image.

17. The aerial vehicle of claim 1, further comprising:
a plurality of range sensors, each range sensor mounted on a respective position on the airframe and configured to measure a distance between the respective position and a nearest surface from the respective position;
a memory storing geometrical information about an enclosed space;
a processor configured to determine a planar position of the aerial vehicle in the enclosed space based on measurements from the plurality of range sensors and further based on the geometrical information.

18. A method of imaging a tunnel, the method comprising:
flying an aerial vehicle along a lengthwise direction of the tunnel;
wherein the aerial vehicle comprises an airframe defining a longitudinal axis, a gimbal coupled to the airframe and a camera mounted on the gimbal to face a direction at least substantially orthogonal to the longitudinal axis;
wherein the longitudinal axis is at least substantially parallel to the lengthwise direction when the aerial vehicle is in flight;
rotating the gimbal while the aerial vehicle is in flight such that the camera revolves around the longitudinal axis to capture a spiral panoramic image; and
reconstructing a virtual three-dimensional model of the tunnel based on the spiral panoramic image.

19. The method of claim 18, further comprising:
obtaining measurements from a range sensor coupled to the camera;
reconstructing the virtual three-dimensional model further based on the measurements.

20. A method of imaging a shaft, the method comprising:
flying an aerial vehicle along a depthwise direction of the shaft;
wherein the aerial vehicle comprises an airframe defining a longitudinal axis, and a camera mounted on the airframe to face a direction at least substantially orthogonal to the longitudinal axis;
wherein the longitudinal axis is at least substantially perpendicular to the depthwise direction when the aerial vehicle is in flight;
rotating the aerial vehicle about the longitudinal axis while the aerial vehicle is in flight such that the camera revolves around the longitudinal axis to capture a spiral panoramic image; and
reconstructing a virtual three-dimensional model of the shaft based on the spiral panoramic image.

21. (canceled)
